(19) United States
(12) Patent Application Publication
(10) Pub. No.: US 2013/0107565 A1
(43) Pub. Date: May 2, 2013

(54) LIGHT DIFFUSING OPTICAL FIBER WITH UV PROTECTION LAYER

(71) Applicant: Michael Lucien Genier, Horseheads, NY (US)

(72) Inventor: Michael Lucien Genier, Horseheads, NY (US)

(21) Appl. No.: 13/661,570

(22) Filed: Oct. 26, 2012

Related U.S. Application Data
(60) Provisional application No. 61/553,438, filed on Oct. 31, 2011.

(51) Int. Cl. G02B 5/02; C03B 37/027; C03B 37/018

(52) U.S. Cl. 362/558; 65/421

(57) ABSTRACT

A light diffusing optical fiber includes a core region and a cladding layer. The fiber is configured to scatter guided light away from the core and through an outer surface. A layer or region of the fiber includes material that converts scattered light to a longer wavelength, which is surrounded by a layer or region including material that blocks ultraviolet light.

### BACKGROUND

This application claims the benefit of priority under 35 U.S.C. §119 of U.S. Provisional Application Ser. No. 61/553438 filed on Oct. 31, 2011 the content of which is relied upon and incorporated herein by reference in its entirety.

The disclosure relates generally to light diffusing optical fibers and more particularly to light diffusing optical fibers having improved ultraviolet (UV) protection and shielding characteristics.

Light diffusing optical fibers or illumination fibers include those intended to provide “linear lighting”, wherein the fiber conducts light from a light source linearly along its length while emitting light from its sides. Such fibers may be useful in a variety of illumination applications, including, but not limited to, medical applications, biological applications, sensor and measurement applications, decorative applications, signage, interior illumination, automotive applications, and consumer electronics. However, at least some of the light emitted from the sides of such fibers may be in the ultraviolet (UV) range, which can be harmful to a user's eyes and/or skin and can also lead to damage of optical sensors or precision instruments in certain types of applications.

### SUMMARY

One embodiment of the disclosure relates to a light diffusing optical fiber. The light diffusing optical fiber includes a core region and a cladding layer. The fiber is configured to scatter guided light away from the core and through an outer surface, the fiber having a scattering-induced attenuation greater than 50 dB/km. A layer or region of the fiber includes material that converts scattered light to a longer wavelength, which is surrounded by a layer or region including material that blocks ultraviolet light.

Another embodiment of the disclosure relates to a method of making a light diffusing optical fiber. The method includes depositing silica soot particles around a bait rod or core cane to form an optical fiber preform. The method also includes consolidating the preform to form a glassy fiber blank. In addition, the method includes drawing the glassy fiber blank to form an optical fiber. The light diffusing optical fiber includes a core region and a cladding layer. The fiber is configured to scatter guided light away from the core and through an outer surface, the fiber having a scattering-induced attenuation greater than 50 dB/km. A layer or region of the fiber includes material that converts scattered light to a longer wavelength, which is surrounded by a layer or region including material that blocks ultraviolet light.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic cross-section of an exemplary embodiment of a light diffusing fiber;

FIG. 2 is a schematic cross-section of an alternative exemplary embodiment of a light diffusing fiber;

FIG. 3 is a schematic cross-section of an alternative exemplary embodiment of a light diffusing fiber;

FIG. 4 is a schematic cross-section of an alternative exemplary embodiment of a light diffusing fiber; and

FIGS. 5A-5D are schematic cross-sections of other cross-sectional geometries that can be utilized in embodiments disclosed herein.

### DETAILED DESCRIPTION

Various embodiments of the disclosure will be described in detail with reference to the drawings, if any.

Embodiments disclosed herein include a light diffusing optical fiber. The light diffusing optical fiber has a core region and a cladding layer. The optical fiber is configured to scatter guided light away from the core and through an outer surface of the fiber such that the fiber has a scattering-induced attenuation of greater than 50 dB/km, such as greater than 100 dB/km, and further such as greater than 200 dB/km, and yet further such as greater than 500 dB/km, and still yet further such as greater than 1000 dB/km, and even still yet further such as greater than 5000 dB/km. Examples of such optical fibers include those comprising a plurality of nano-sized structures in at least one of the core region and cladding layer, such as the fibers disclosed in U.S. published patent application no. 2011/0122646, the entire disclosure of which is incorporated herein by reference. Preferably, the fiber emits substantially uniform radiation over its length.

For example, a region that comprises a plurality of nano-sized structures includes a region or area with a large number (greater than 50) of gas filled voids, or other nano-sized structures, e.g., more than 50, more than 100, or more than 200 voids in the cross-section of the fiber. The gas filled voids may contain, for example, SO₂, Kr, Ar, CO₂, N₂, O₂, or mixture thereof. The cross-sectional size (e.g., diameter) of nano-sized structures (e.g., voids) as described herein may vary from 10 nm to 1 μm (for example, 50 nm-500 nm), and the length may vary from 1 millimeter 50 meters (e.g., 2 mm to 5 meters, or 5 mm to 1 m range).

Preparation of optical fibers comprising a plurality of nano-sized structures can, for example, be formed by depositing an amount (e.g., 470 grams) of SiO₂ (0.5 g/cc density) soot via outside vapor deposition (OVD) onto a fully consolidated 1 meter long, 20 mm diameter pure silica void-free core cane, resulting in a preform assembly (sometimes referred to as a preform, or an optical preform) comprising a consolidated void-free silica core region surrounded by a soot silica region. The soot cladding of this perform assembly can then be sintered by first drying for 2 hours in an atmosphere comprising helium and 3 percent chlorine (all percent gases by volume) at 1100° C. in the upper-zone part of the furnace, followed by down driving at 200 mm/min (corresponding to approximately a 100° C./min temperature increase for the outside of the soot preform during the downdrive process) through a hot zone set at approximately 1500° C. in a 100 percent SO₂ (by volume) sintering atmosphere. The preform assembly can then be down driven again (i.e., a second time) through the hot zone at the rate of 100 mm/min (corresponding to an approximately 50° C./min temperature increase for the outside of the soot preform during the downdrive process). The preform assembly can then be down driven again (i.e., a third time) through the hot zone at the rate of 50 mm/min (corresponding to an approximately 25° C./min temperature increase for the outside of the soot preform during the downdrive process). The preform assembly can then be down driven again (i.e., a fourth time) through the hot zone at the rate of 25 mm/min (corresponding to an approximately 12.5° C./min temperature increase for the outside of the soot preform during the downdrive process), then finally sintered at 6 mm/min (approximately 3° C./min heat up rate) in order to sinter the soot into an SO₂-seeded silica overclad preform. Following each downdrive step, the preform assembly can be updriven at 200 mm/min into the upper-zone part of the furnace (which can remain set at 1100° C.). The first series of higher downfeed rate can be employed to glaze the outside of the optical fiber preform, which facilitates trapping of the gases in the preform. The preform can then be placed for 24 hours in an argon purged holding oven set at 1000° C. to outgas any remaining helium in the preform. This preform can then be redrawn in an argon atmosphere on a conventional graphite redraw furnace set at approximately 1700° C. into void-free SiO₂ core, SO₂-seeded (i.e., containing the non-periodically located voids containing SO₂ gas) silica overclad canes which were 10 mm in diameter and 1 meter long.

One of the 10 mm canes can then be placed back in a lathe where an additional amount (e.g., about 190 grams) of additional SiO₂ (0.52 g/cc density) soot can be deposited via OVD. The soot of this cladding (which may be called overcladding) for this assembly can then be sintered by first drying for 2 hours in an atmosphere comprising helium and 3 percent chlorine at 1100° C. followed by down driving at 5 mm/min through a hot zone set at 1500° C. in a 100% helium (by volume) atmosphere in order to sinter the soot to a germania containing void-free silica core, silica SO₂-seeded ring (i.e., silica with voids containing SO₂), and void-free overclad preform. The preform can then be placed for 24 hours in an argon purged holding oven set at 1000° C. to outgas any remaining helium from the preform. The optical fiber preform can then be drawn to 3 km lengths of 125 micron diameter optical fiber at approximately 1900° C. to 2000° C. in a helium atmosphere on a graphite resistance furnace. The temperature of the optical preform can be controlled by monitoring and controlling the optical fiber tension, such as being held at one value between 30 and 600 grams during each portion (e.g., 3 km lengths) of a fiber draw run. The fiber can be coated with a low index silicon based coating during the draw process.

Another 10 mm void-free silica core SO₂-seeded silica overclad canes described above (i.e., a second cane) can also be utilized to manufacture the optical preform and fibers. More specifically, the second 10 mm void-free silica core SO₂-seeded silica overclad cane can be placed back in a lathe where an amount (e.g., about 3750) grams of additional SiO₂ (0.67 g/cc density) soot can be deposited via OVD. The soot of this cladding (which may be called overcladding for this assembly) can then be sintered by first drying for 2 hours in an atmosphere comprising helium and 3 percent chlorine at 1100° C., followed by down driving at 5 mm/min through a hot zone set at 1500° C. in a 100% helium (by volume) atmosphere in order to sinter the soot so as to produce preform comprising germania containing void-free silica core, silica SO₂-seeded ring (i.e. silica with voids containing SO₂), and void-free overclad. The resultant optical fiber preform can be placed for 24 hours in an argon purged holding oven set at 1000° C. to outgas any remaining helium from the preform. Finally, the optical fiber preform can be drawn to a length (e.g., 5 km) of 125 micron diameter optical fiber and coated with low index polymer.

In certain exemplary embodiments, the uniformity of illumination along the fiber length is controlled such that the minimum scattering illumination intensity is not less than 0.7 of the maximum scattering illumination intensity, by controlling fiber tension during the draw process or by selecting an appropriate draw tension (e.g., between 30 g and 100 g, or between 40 g and 90 g).

The numerical aperture (NA) of fiber is preferably equal to or greater than the NA of a light source directing light into the fiber. Preferably the numerical aperture (NA) of fiber is greater than 0.2, in some embodiments greater than 0.3, and even more preferably greater than 0.4.

The fiber can be coupled to a light source that that generates light within a wavelength range, such as a range including wavelengths between about 200 and 2000 nm, such as between about 200 and 1000 nm, and further such as between about 200 and 500 nm.

A layer or region of the fiber includes material that converts scattered light to a longer wavelength. An example of a material that converts scattered light to a longer wavelength is phosphor. A phosphor is a substance that exhibits luminescence, upon exposure to specific wavelengths of light. Examples of phophors include; Cu—ZnS, colloidal metals, rare earth metals, such as Eu, Tb, and Pr, and, transitional metal ions, such as Mn and Sn, and organic dyes.

Such material can convert at least some scattered light to a wavelength that is at least 10 nm, such as at least 20 nm, and further such as at least 50 nm, and yet further such as at least 100 nm, and still yet further such as at least 200 nm longer than the wavelength of incident light. For example, in preferred embodiments, such material can convert at least some ultraviolet (UV) light to light in a visible wavelength range. Such material can, in preferred embodiments, convert at least some visible light in a shorter wavelength range (e.g., violet or blue light) to visible light in a longer wavelength range (e.g., green or red light). Such material can also, in certain preferred embodiments, convert at least some visible light to infrared (IR) light.

The material that converts scattered light into a longer wavelength is preferably added to the layer or region comprising material that converts scattered light into a longer wavelength such that the layer or region comprising material that converts scattered light to a longer wavelength converts at least some scattered light to a wavelength that is at least 10 nm, such as at least 20 nm, and further such as at least 50 nm, and yet further such as at least 100 nm, and still yet further such as at least 200 nm longer than the wavelength of incident light. For example, in preferred embodiments, the layer or region comprising material that converts scattered light to a longer wavelength can convert at least some ultraviolet (UV) light to light in a visible wavelength range. Such layer or region can, in preferred embodiments, convert at least some visible light in a shorter wavelength range (e.g., violet or blue light) to visible light in a longer wavelength range (e.g., green or red light). Such layer or region can also, in certain preferred embodiments, convert at least some visible light to infrared (IR) light.

The layer or region that converts scattered light to a longer wavelength is surrounded by a layer or region comprising material that blocks ultraviolet light. The material that blocks ultraviolet light preferably absorbs or reflects at least 90% of light having a wavelength of between 10 and 400 nm, such as at least 95% of the light having a wavelength of between 10 and 400 nm, and further such as at least 99% of the light having a wavelength of between 10 and 400 nm, and still further such as substantially all of the light having a wavelength of between 10 and 400 nm. The material that blocks ultraviolet light preferably transmits at least 50% of light having a wavelength between 400 and 800 nm, such as at least 60% of light having a wavelength between 400 and 800 nm, and further such as at least 70% of light having a wavelength between 400 and 800 nm.

The material that blocks ultraviolet light is preferably added to the layer or region comprising material that blocks ultraviolet light such that the layer or region comprising material that blocks ultraviolet light absorbs or reflects at least 90% of light having a wavelength of between 10 and 400 nm, such as at least 95% of the light having a wavelength of between 10 and 400 nm, and further such as at least 99% of the light having a wavelength of between 10 and 400 nm, and still further such as substantially all of the light having a wavelength of between 10 and 400 nm. The layer or region comprising material that blocks ultraviolet light preferably transmits at least 50% of light having a wavelength between 400 and 800 nm, such as at least 60% of light having a wavelength between 400 and 800 nm, and further such as at least 70% of light having a wavelength between 400 and 800 nm.

Examples of materials that block ultraviolet light include uv blocking polymers, such as polycarbonates and acrylics, uv blocking glasses, such as cerium doped silica, an example of which is Vycor-UV® available from Corning Incorporated, and glasses coated with a uv blocking material, such as Optivex™ UV blocking coating available from Applied Coatings Group.

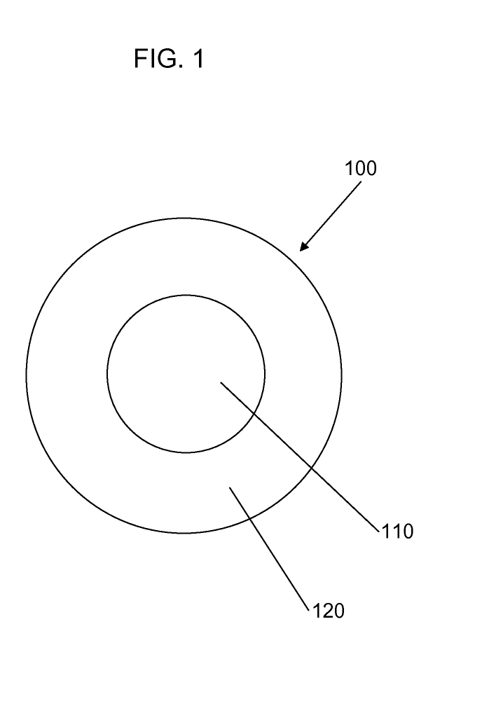

FIG. 1 illustrates a schematic cross section of an exemplary embodiment of a light diffusing optical fiber. Light diffusing optical fiber 100 includes core region 110 and cladding layer 120. Core region 110 includes at least one material that converts scattered light to a longer wavelength. Cladding layer 120 includes material that blocks ultraviolet light. Optical fiber 100 may be additionally coated with one or more coating layers (not shown).

The embodiment illustrated in FIG. 1 may, for example, be prepared by first depositing silica soot particles around a bait rod, using for example, an outside vapor deposition (OVD) process. At some point, while the soot is being deposited, material that converts scattered light to a longer wavelength, such as phosphor material, is introduced via at least one of, for example, combustion of a precursor gas, such as EuCl₃, solution doping and spraying particles of the material directly on the soot.

The material that converts scattered light to a longer wavelength, can for example, comprise at least 10 PPM, such as at least 50 PPM and further such as at least 100 PPM, and still further such as at least 500 PPM of the material deposited around the bait rod.

The material that converts scattered light to a longer wavelength can be deposited at varying stages during the deposition process. For example, in one exemplary embodiment, the material that converts scattered light to a longer wavelength can be deposited in an intermediate stage of the deposition process, such that some of the soot is deposited before any of the material that converts scattered light to a longer wavelength is deposited and some of the soot is deposited after all of the material that converts light to a longer wavelength is deposited. In an alternative exemplary embodiment, the material that converts scattered light to a longer wavelength is deposited at or near the end of the deposition process, such that all or nearly all of the soot is deposited before any of the material that converts light to a longer wavelength is deposited. The material that converts scattered light to a longer wavelength may also be deposited at two or more separate times during the deposition process, such that the resulting soot object contains at least two layers comprising material that converts scattered light to a longer wavelength. When deposited at two or more separate times, the material that converts scattered light to a longer wavelength may be the same or different. The material that converts scattered light to a longer wavelength may also be applied throughout the deposition process and may change, either gradually or abruptly, from a first to at least a second material during that process.

Following deposition, the bait rod can be removed and the soot object consolidated into a glassy solid core cane, wherein the core cane comprises a material that converts scattered light to a longer wavelength, such as phosphor.

The core cane can then be reintroduced into a soot deposition chamber, wherein additional silica soot is applied to form at least one cladding layer. At least one of the cladding layer or layers includes at least one material that blocks ultraviolet light. The material that blocks ultraviolet light, can for example, comprise at least 10 PPM, such as at least 50 PPM, and further such as at least 100 PPM, and still further such as at least 500 PPM of the material deposited around the core cane.

The material that blocks ultraviolet light can be deposited at varying stages during the deposition process. For example, in one exemplary embodiment, the material that blocks ultraviolet light can be deposited in an intermediate stage of the deposition process, such that some of the soot is deposited before any of the material that blocks ultraviolet light is deposited and some of the soot is deposited after all of the material that blocks ultraviolet light is deposited. In an alternative exemplary embodiment, the material that blocks ultraviolet light is deposited at or near the end of the deposition process, such that all or nearly all of the soot is deposited before any of the material that blocks ultraviolet light is deposited. The material that blocks ultraviolet light may also be deposited at two or more separate times during the deposition process, such that the resulting object contains at least two layers comprising material that blocks ultraviolet light. When deposited at two or more separate times, the material that blocks ultraviolet light may be the same or different. The material that blocks ultraviolet light may also be applied throughout the deposition process and may change, either gradually or abruptly, from a first to at least a second material during that process.

The resulting soot blank may then be treated with heat and chemicals (e.g., chlorine) and consolidated to form a glassy fiber blank. The fiber blank may then be heated and drawn into a fiber, following which the fiber may be coated with at least one coating layer, such as at least one of an acrylic, polyamide or another type of protective coating, which may then be cured, such as via UV curing.

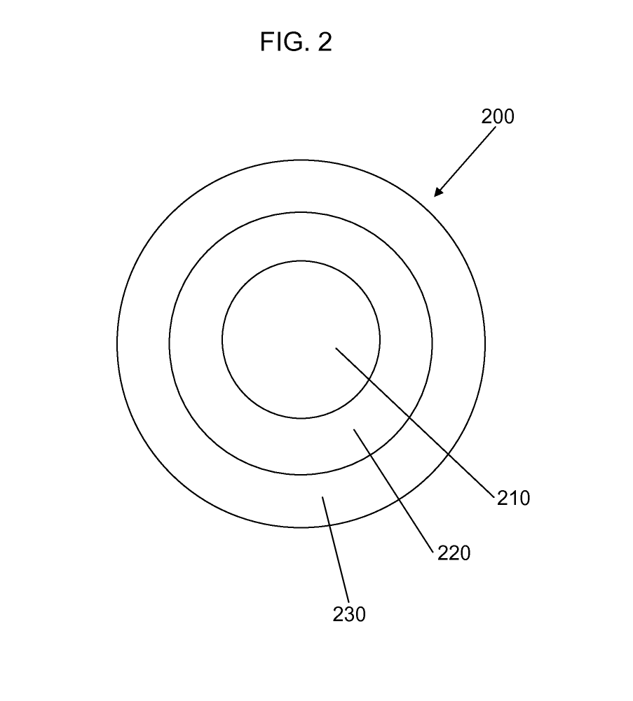

FIG. 2 illustrates a schematic cross section of another exemplary embodiment of a light diffusing optical fiber. Light diffusing optical fiber 200 includes core region 210, first cladding layer 220, and second cladding layer 230. First cladding layer 220 includes material that converts scattered light to a longer wavelength. Second cladding layer 230 surrounds first cladding layer 220 and includes material that blocks ultraviolet light. Optical fiber 200 may be additionally coated with one or more coating layers (not shown).

The embodiment illustrated in FIG. 2 may, for example, be generally prepared by the same method as described above for the embodiment illustrated in FIG. 1 except both the material that converts scattered light to a longer wavelength and the material that blocks ultraviolet light are deposited on a previously consolidated core cane. Specifically, the core cane can be reintroduced into a soot deposition chamber, wherein additional silica soot is applied to form at least one cladding layer. At least one of the cladding layer or layers includes at least one material, such as phosphor, that converts scattered light to a longer wavelength. Surrounding this layer or layers is a cladding layer or layers that includes at least one material that blocks ultraviolet light. Such materials can be introduced to the cladding layers via at least one of, for example, combustion of a precursor gas and spraying particles of the material directly on the soot.

The material that converts scattered light to a longer wavelength and the material that blocks ultraviolet light can be deposited at varying stages during the deposition process. For example, in one exemplary embodiment, the material that converts scattered light to a longer wavelength can be deposited in a stage of the deposition process that immediately precedes deposition of the material that blocks ultraviolet light such that the material that blocks ultraviolet light immediately surrounds the material that converts scattered light to a longer wavelength. In an alternative exemplary embodiment, the material that converts scattered light to a longer wavelength and the material that blocks ultraviolet light can be deposited in separate deposition steps, wherein between those steps, silica soot material is deposited such that the material that converts scattered light to a longer wavelength is not immediately adjacent to material that blocks ultraviolet light (e.g., there is an amount of undoped silica soot between these two materials). The material that converts scattered light to a longer wavelength and the material that blocks ultraviolet light may also each be deposited at two or more separate times during the deposition process, such that the resulting object contains at least two layers comprising material that converts scattered light to a longer wavelength and at least two layers comprising material blocks ultraviolet light. When deposited at two or more separate times, each of the material that converts scattered light to a longer wavelength and the material that blocks ultraviolet light may be the same or different.

The resulting soot blank may then be treated with heat and chemicals (e.g., chlorine) and consolidated to form a glassy fiber blank. The fiber blank may then be heated and drawn into a fiber, following which the fiber may be coated with at least one coating layer, such as at least one of an acrylic, polyamide or another type of protective coating, which may then be cured, such as via UV curing.

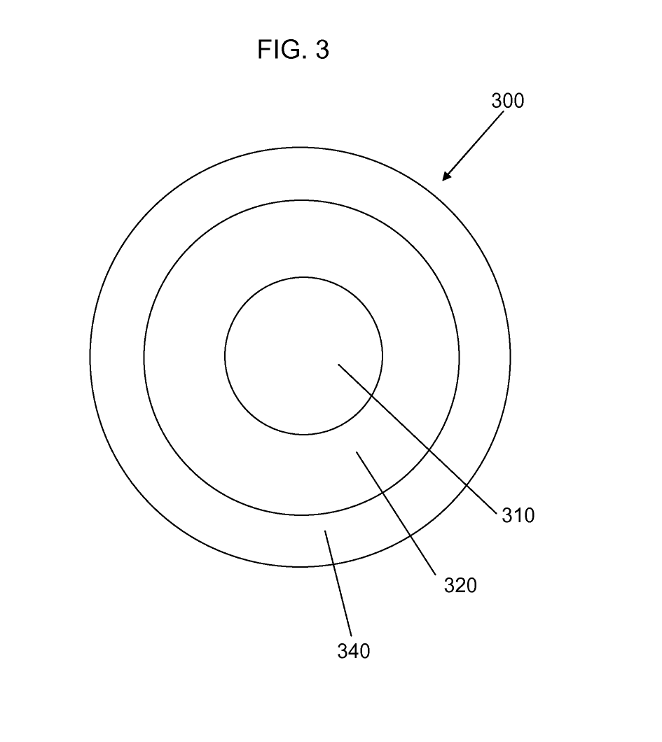

FIG. 3 illustrates a schematic cross section of another exemplary embodiment of a light diffusing optical fiber. Light diffusing optical fiber 300 includes core region 310 and cladding layer 320. Cladding layer 320 is surrounded by a layer or region comprising material that converts scattered light to a longer wavelength. Cladding layer is also surrounded by at least a primary coating layer 340, which may be additionally surrounded by at least one other coating layer (not shown).

In certain exemplary embodiments, the primary coating layer may be a relatively low modulus layer (typically <3 MPa), which is surrounded by a higher-modulus secondary coating layer (typically >50 MPa). Other, or additional coatings, applied either as a single layer coating or as a layer in a multi-layer coating may also be utilized, such as one or more hydrophobic coating layers. Optical fibers as disclosed herein may also be enclosed within a polymeric, metal, or glass covering (or coatings).

In a preferred set of embodiments, wherein cladding layer 320 is surrounded by a layer or region comprising material that converts scattered light to a longer wavelength, coating layer 340 surrounds the layer or region comprising material that blocks ultravoilet light. In this set of embodiments, both layer or region comprising material that blocks ultraviolet light and layer or region comprising material that converts scattered light to a longer wavelength are between cladding layer 320 and coating layer 340 and the layer or region comprising material that blocks ultraviolet light surrounds layer or region comprising material that converts scattered light to a longer wavelength.

The embodiment illustrated in FIG. 3 may, for example, be prepared by first depositing silica soot particles around a bait rod, using for example, an outside vapor deposition (OVD) process. The core cane can then be reintroduced into a soot deposition chamber, wherein additional silica soot is applied to form at least one cladding layer. The resulting soot blank may then be treated with heat and chemicals (e.g., chlorine) and consolidated to form a glassy fiber blank. The fiber blank may then be heated and drawn into a fiber. To this drawn fiber, a layer comprising material that converts scattered light to a longer wavelength, such as phosphor, can be applied directly to the surface of the fiber. This application can, for example, be in the form of inkjet nozzles or via a liquid bath coating process. The coating may then be dried, or alternatively cured (e.g., via UV light curing). Next, a layer comprising material that blocks ultraviolet light can be applied directly to the layer comprising material that converts scattered light to a longer wavelength. This application can, for example, be in the form of inkjet nozzles or via a liquid bath coating process. The coating may then be dried, or alternatively cured (e.g.., via UV curing). Next, the fiber may be coated with at least one coating layer, such as at least one of an acrylic, polyamide or another type of protective coating, which may then be cured, such as via UV curing.

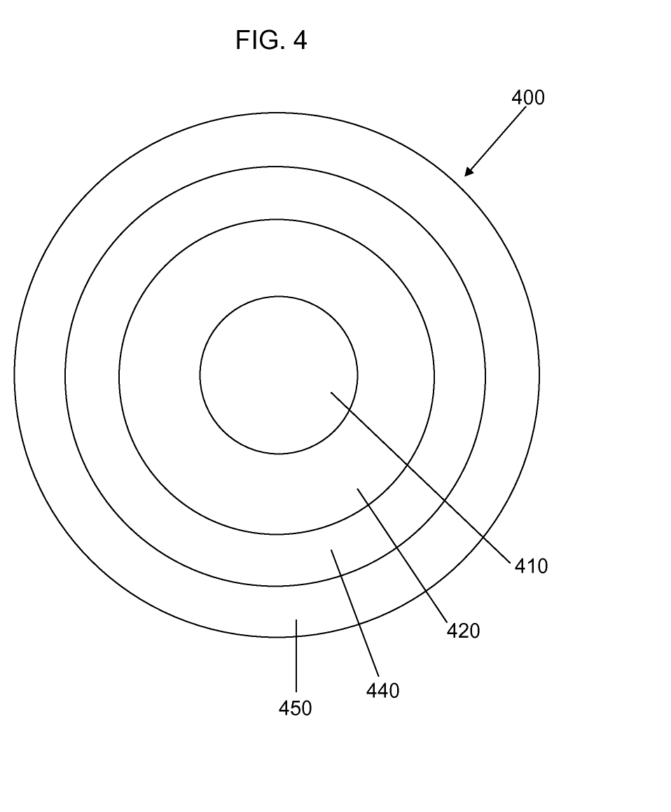

FIG. 4 illustrates a schematic cross section of another exemplary embodiment of a light diffusing optical fiber. Light diffusing optical fiber 400 includes core region 410 and cladding layer 420, first coating layer 440, and second coating layer 450. At least one of first coating layer and second coating layer includes material that converts scattered light to a longer wavelength.

In a preferred set of embodiments, wherein at least one of first coating layer and second coating layer includes material that converts scattered light to a longer wavelength, first coating layer includes material that converts scattered light to a longer wavelength and second coating layer includes material that blocks ultraviolet light.

In another preferred set of embodiments, wherein at least one of first coating layer and second coating layer includes material that converts scattered light to a longer wavelength, second coating layer or region is surrounded by a layer or region that includes material that blocks ultravoilet light.

The embodiment illustrated in FIG. 4 may, for example, be generally prepared by the same method as described above for the embodiment illustrated in FIG. 3 up through the step of preparing a drawn fiber. Next, the fiber may be coated with two or more coating layers, wherein the coating layers include at least one of an acrylic, polyamide or another type of protective coating, which may then be cured, such as via UV curing. At least one of the coating layers includes material, such as phosphor, that converts scattered light into a longer wavelength. The material that converts scattered light to a longer wavelength, can for example, comprise at least 0.1%, such as at least 0.5%, and further such as at least 1% of at least one coating layer.

In a preferred set of embodiments, a first coating layer includes material, such as phosphor, that converts scattered light into a longer wavelength. The material that converts scattered light to a longer wavelength, can for example, comprise at least 0.1%, such as at least 0.5%, and further such as at least 1% of the first coating layer. A second coating layer is then applied that includes material that blocks ultraviolet light. The material that blocks ultraviolet light, can for example, comprise at least 0.1%, such as at least 0.5%, and further such as at least 1% of the second coating layer. A third coating layer, such as a standard acrylic, polyimide, or another type of protective coating may be optionally applied.

The embodiments described above with reference to FIGS. 1-4 are non-limiting and other embodiments are also viewed as being within the scope of the present disclosure. For example, in another set of preferred embodiments, at least one cladding layer, such as in embodiments described in reference to FIG. 2, includes material, such as phosphor, that converts scattered light to a longer wavelength. Once such fiber has been drawn, a layer including material that blocks ultraviolet light can be applied directly to the surface of the fiber. This application can, for example, be in the form of inkjet nozzles or via a liquid bath coating process, such as in embodiments described in reference to FIG. 3.

In another set of preferred embodiments, at least one cladding layer, such as in embodiments described in reference to FIG. 2, includes material, such as phosphor, that converts scattered light to a longer wavelength. Once such fiber has been drawn, the fiber may be coated with at least one coating layer, wherein the at least one coating layer includes at least one of an acrylic, polyamide or another type of protective coating, which may then be cured, such as via UV curing. At least one coating layer includes material that blocks ultraviolet light.

In another set of preferred embodiments, a fiber is prepared and drawn as in embodiments described in reference to FIG. 3. Once such fiber has been drawn, a layer including material, such as phosphor, that converts scattered light to a longer wavelength is applied directly to the surface of the fiber. This application can, for example, be in the form of inkjet nozzles or via a liquid bath coating process, such as in embodiments described in reference to FIG. 3. Next, the fiber may be coated with at least one coating layer, such as at least one of an acrylic, polyamide or another type of protective coating, which may then be cured, such as via UV curing. At least one coating layer includes material that blocks ultraviolet light.

In another set of preferred embodiments, the fiber includes a first cladding layer and a second cladding layer as in FIG. 2, wherein first cladding layer includes material, such as phosphor, that converts scattered light to a longer wavelength and second cladding layer surrounds first cladding layer and includes material that blocks ultraviolet light. Once such fiber has been drawn, the fiber may be coated with at least one coating layer, wherein the at least one coating layer includes at least one of an acrylic, polyamide or another type of protective coating, which may then be cured, such as via UV curing. At least one coating layer includes material that blocks ultraviolet light.

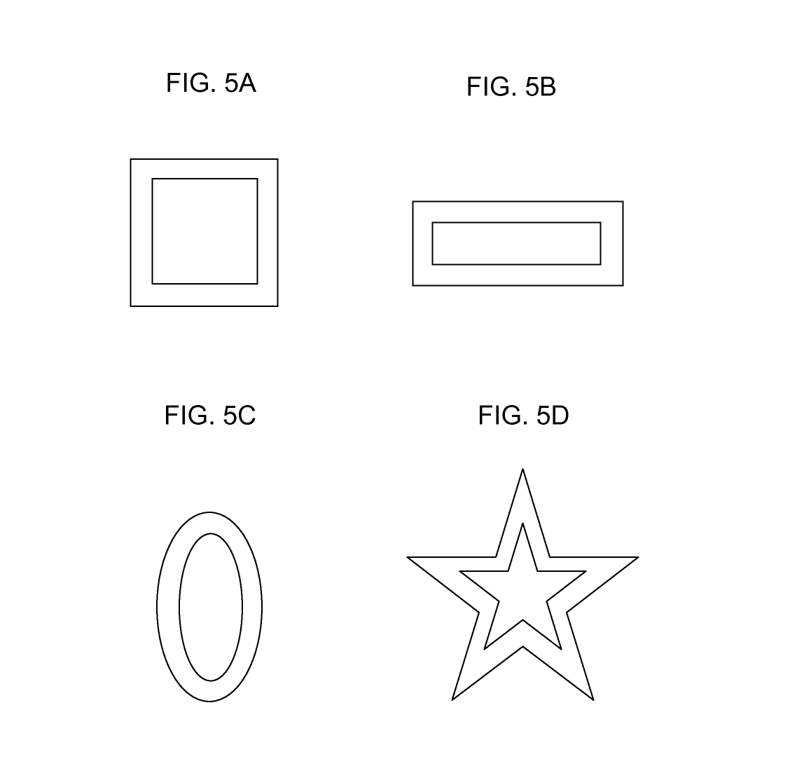

While FIGS. 1-4 show embodiments comprising an optical fiber having a generally circular cross-section, cross sections utilizing any of the above disclosure are to be understood as being not so limited. FIGS. 5A-D show other exemplary cross sections that can utilize one or more of the embodiments disclosed herein, including square (FIG. 5A), rectangular (FIG. 5B), elliptical (FIG. 5C) or star (FIG. 5D).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention as set forth in the appended claims. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

What is claimed is:

1. A light diffusing optical fiber comprising:
a core region and a cladding layer, wherein the fiber is configured to scatter guided light away from the core and through an outer surface, said fiber having a scattering-induced attenuation greater than 50 dB/km, and wherein a layer or region of the fiber comprises material that converts scattered light to a longer wavelength, wherein said layer or region is surrounded by a layer or region comprising material that blocks ultraviolet light.

2. The optical fiber of claim 1, wherein the material that converts scattered light to a longer wavelength comprises phosphor.

3. The optical fiber of claim 1, wherein the material that blocks ultraviolet light absorbs or reflects at least 90% of light having a wavelength of between 10 and 400 nm and transmits at least 50% of light having a wavelength between 400 and 800 nm.

4. The optical fiber of claim 1, wherein the cladding layer is surrounded by the layer or region comprising material that converts scattered light to a longer wavelength.

5. The optical fiber of claim 4, wherein the optical fiber comprises a coating layer, wherein the coating layer surrounds the layer or region comprising material that blocks ultravoilet light.

6. The optical fiber of claim 1, wherein the core region comprises material that converts scattered light to a longer wavelength and the cladding layer comprises material that blocks ultraviolet light.

7. The optical fiber of claim 1, wherein the cladding layer comprises a first cladding layer and a second cladding layer, wherein the first cladding layer comprises material that converts scattered light to a longer wavelength and the second cladding layer comprises material that blocks ultraviolet light.

8. The optical fiber of claim 1, wherein the cladding layer comprises material that converts scattered light to a longer wavelength and the optical fiber comprises a coating layer, said coating layer comprising material that blocks ultraviolet light.

9. The optical fiber of claim 1, wherein the optical fiber comprises a first coating layer and a second coating layer, said first coating layer comprising material that converts scattered light to a longer wavelength and said second coating layer comprising material that blocks ultraviolet light.

10. The optical fiber of claim 1, wherein the fiber comprises a plurality of nano-sized structures in at least one of the core region and cladding layer.

11. A method of making a light diffusing optical fiber, the method comprising:
depositing silica soot particles around a bait rod or core cane to form an optical fiber preform;
consolidating the preform to form a glassy fiber blank;
drawing the glassy fiber blank to form an optical fiber;
wherein the fiber comprises a core region and a cladding layer, and wherein the fiber is configured to scatter guided light away from the core and through an outer surface, said fiber having a scattering-induced attenuation greater than 50 dB/km, and wherein a layer or region of the fiber comprises material that converts scattered light to a longer wavelength, wherein said layer or region is surrounded by a layer or region comprising material that blocks ultraviolet light.

12. The method of claim 11, wherein the material that converts scattered light to a longer wavelength comprises phosphor.

13. The method of claim 11, wherein the material that blocks ultraviolet light absorbs or reflects at least 90% of light having a wavelength of between 10 and 400 nm and transmits at least 50% of light having a wavelength between 400 and 800 nm.

14. The method of claim 11, wherein the cladding layer is surrounded by the layer or region comprising material that converts scattered light to a longer wavelength.

15. The method of claim 14, wherein the optical fiber comprises a coating layer, wherein the coating layer surrounds the layer or region comprising material that blocks ultravoilet light.

16. The method of claim 11, wherein the core region comprises material that converts scattered light to a longer wavelength and the cladding layer comprises material that blocks ultraviolet light.

17. The method of claim 11, wherein the cladding layer comprises a first cladding layer and a second cladding layer, wherein the first cladding layer comprises material that converts scattered light to a longer wavelength and the second cladding layer comprises material that blocks ultraviolet light.

18. The method of claim 11, wherein the cladding layer comprises material that converts scattered light to a longer wavelength and the optical fiber comprises a coating layer, said coating layer comprising material that blocks ultraviolet light.

19. The method of claim 11, wherein the optical fiber comprises a first coating layer and a second coating layer, said first coating layer comprising material that converts scattered light to a longer wavelength and said second coating layer comprising material that blocks ultraviolet light.

20. The method of claim 11, wherein the fiber comprises a plurality of nano-sized structures in at least one of the core region and cladding layer.
